(19) United States
(12) Patent Application Publication
(10) Pub. No.: US 2012/0256927 A1
(43) Pub. Date: Oct. 11, 2012

(54) APPARATUS AND METHOD FOR SCRAPPING IN A DEVICE WITH TOUCH SCREEN

(75) Inventors: Kwang-Sub SON, Gyeonggi-do (KR); Soon-Jin KIM, Gyeonggi-do (KR)

(73) Assignee: SAMSUNG ELECTRONICS CO., LTD., Gyeonggi-Do (KR)

(21) Appl. No.: 13/323,925

(22) Filed: Dec. 13, 2011

(30) Foreign Application Priority Data
Apr. 5, 2011 (KR) 10-2011-0030995

(51) Int. Cl. G06T 11/20; G06F 3/041

(52) U.S. Cl. 345/443; 345/173

(57) ABSTRACT

An apparatus and method for scrapping in a device with a touch screen are provided. The scrapping method includes determining whether a scrap command occurs. If the scrap command occurs, the method proceeds with separation of a scrap region from a tension point, and, if a separation line representing a progress trace of separation reaches a boundary of scrap possible regions, the method determines a region surrounded by at least one separation line and at least one boundary as the scrap region.

### CLAIM OF PRIORITY

This application claims the benefit of the earlier filling data, under 35 U.S.C. §119, from patent application No. Serial No. 10-2011-0030995 filed in the Korean Intellectual Property Office on Apr. 5, 2011, the contents of which are incorporated by reference in its entirety.

### BACKGROUND OF THE INVENTION

1. Field of the Invention

The present invention relates to a device with a touch screen. More particularly, the present invention relates to an apparatus and method for scrapping contents displayed on a touch screen using a touch input.

2. Description of the Related Art

In a conventional display device with no touch screen, copying, capturing or scrapping the contents of a Web page, an electronic book and the like, requires executing a series of actions using a separate input means, for example, a pointer, to point to the portion intended to be copied, etc., and blocking a predetermined region within which the portion is contained. Since the introduction and availability of touch screen display devices, the touch screens have now become the display device of choice in many hand-held portable electronic devices. But while touch screen technology is now implemented in many hand-held portable electronic devices, only the input means but not the actual conventional process of copying, capturing or scrapping screen-displayed has changed.

FIG. 1 illustrates a method for scrapping displayed screen content (scrapping method) according to the conventional art. To implement the conventional scrapping method, a user enters a select mode through a predetermined operation (e.g., a double click, a long press/touch), i.e., a scrapping mode, and using the cursor designates a predetermined region 110 containing the screen-displayed content to be scrapped. After the region designation is completed, the device displays a predefined executable menu 120 to the user. The user selects a desired function from the menu 120, and the function is implemented upon the content in the user-designated predetermined region.

As described above, however, even with the development of touch screens, there is heretobefore no known advantage of utilizing touch screens to improve conventional scrapping processes, and touch screen based devices that implement same.

### SUMMARY OF THE INVENTION

Accordingly, the present invention provides an apparatus and method for scrapping contents displayed on a screen in a device with a touch screen, which overcomes the shortcomings of conventional scrapping methods and devices.

To that end, the present invention provides a method for scrapping a desired portion of content quickly in a device with a touch screen.

In an embodiment, the present invention provides a scrap function implemented by an intuitive interface in a device with a touch screen.

In a method embodiment, the invention includes determining whether a scrap command occurs, i.e., is initiated by a user of the device in which the method is implemented, and if the scrap command occurs, proceeding with a separation of a scrap region from a tension point. Where a separation line representing a progress trace of separation reaches a boundary of possible scrap regions, the method intuitively selects a region surrounded by at least one separation line and at least one boundary as the scrap region.

In a device embodiment, the invention utilizes the touch screen for recognizing a user's touch input, and a controller for determining whether a scrap command implemented by the touch input has occurred. If the controller determines that the scrap command has occurred, the device implements separation of a scrap region from a tension point. Where a separation line representing a progress trace of separation reaches a boundary of possible scrap possible regions, a region surrounded by at least one separation line and at least one boundary is determined to be the scrap region.

### BRIEF DESCRIPTION OF THE DRAWINGS

The above features and advantages of certain exemplary embodiments of the present invention will become more apparent from the following detailed description when taken in conjunction with the accompanying drawings, in which:

FIG. 1 is a diagram illustrating a scrapping method according to the conventional art;

FIGS. 2A to 2D are diagrams illustrating a scrapping method in a device with a touch screen according to the invention;

FIG. 3 is a diagram illustrating a form of separation expression of scrapped contents in a device with a touch screen according to the invention;

FIGS. 4A and 4B are diagrams illustrating a method for determining scrap or non-scrap in a device with a touch screen according to the invention;

FIG. 5 is a diagram illustrating a method for processing scrapped contents in a device with a touch screen according to an exemplary embodiment of the present invention;

FIG. 6 is a flowchart illustrating one embodiment of an operation procedure of a device with a touch screen according to the invention;

FIG. 7 is a flowchart illustrating another embodiment of operation procedure of a device with a touch screen according to the invention; and

FIG. 8 is a block diagram illustrating a construction of a device with a touch screen according to the invention.

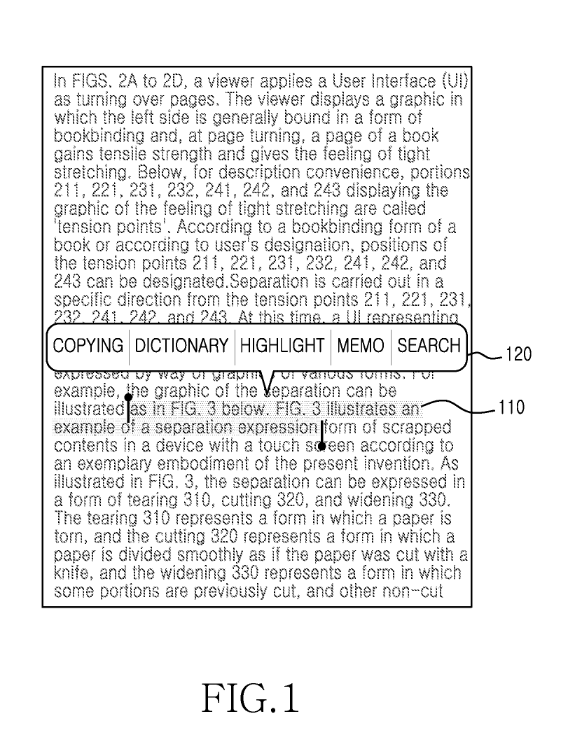

Throughout the drawings, like reference numerals will be understood to refer to like parts, components and structures.

### DETAILED DESCRIPTION

The following description, with reference to the accompanying drawings, is provided to assist a person of ordinary skill in the art with a comprehensive understanding of exemplary embodiments of the present invention as defined by the claims. The description includes various specific details to assist in that understanding but these details are to be regarded as merely exemplary. Accordingly, those of ordinary skill in the art will recognize that various changes and modifications of the exemplary embodiments described herein can be made without departing from the scope and spirit of the invention as defined by the appended claims. Also, descriptions of well-known functions and constructions may be omitted for conciseness and so as not to obscure appreciation of the present invention by a person of ordinary skill with such well-known functions and constructions.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims.

It is to be understood that the singular forms “a”, “an”, and “the” include plural references unless the context clearly dictates otherwise. Thus, for example, reference to “a component surface” typically includes reference to one or more of such surfaces.

By the term “substantially” typically means that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Preferred embodiments of the present invention will be described below with reference to the accompanying drawings

Exemplary embodiments of the present invention provide a technology for scrapping contents displayed on a screen in a device with a touch screen. Such exemplary embodiments provide for the scrapping using one or two touch inputs in order to scrap a desired portion to be scrapped quickly. The scrapping technology is applicable to all portable hand-held electronic devices and terminals such as cellular phones, Personal Communication Systems (PCS), Personal Digital Assistants (PDA), International Mobile Telecommunication—2000 (IMT-2000) terminals and the like, as well as other devices including touch screens, such as laptop computers, tablet Personal Computers (PC) and the like.

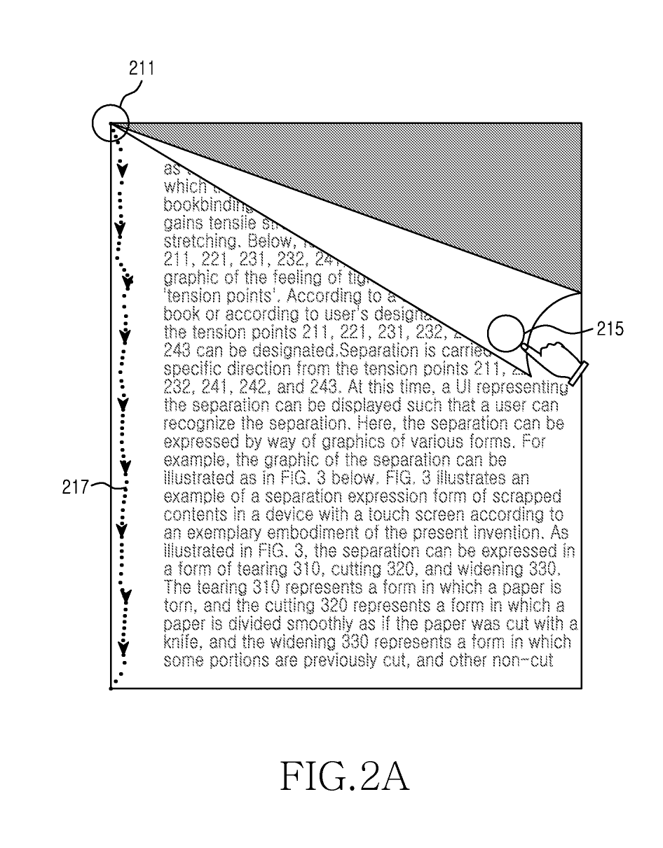

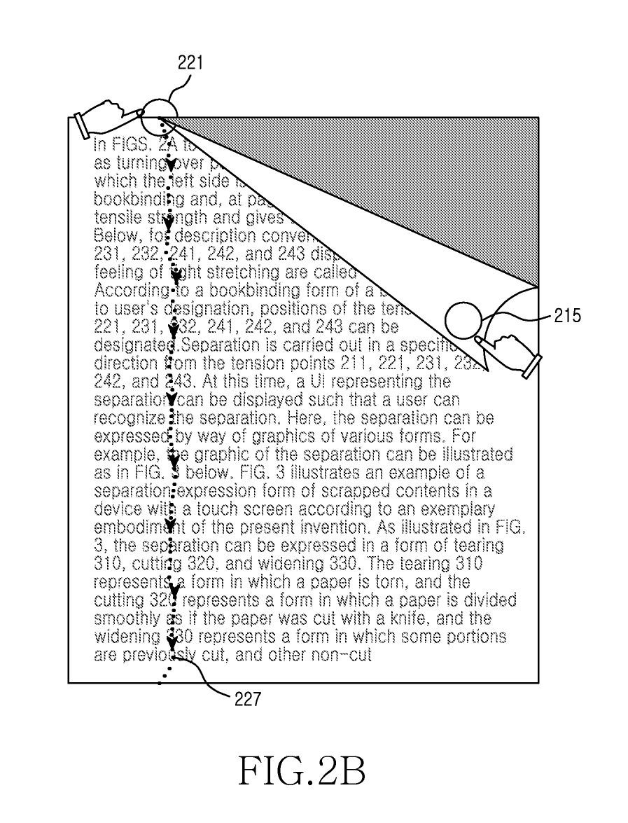

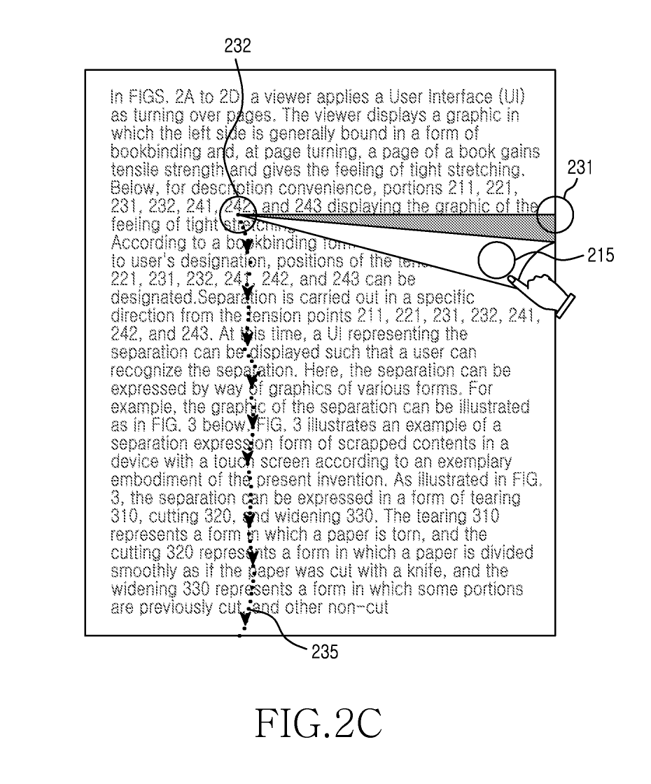

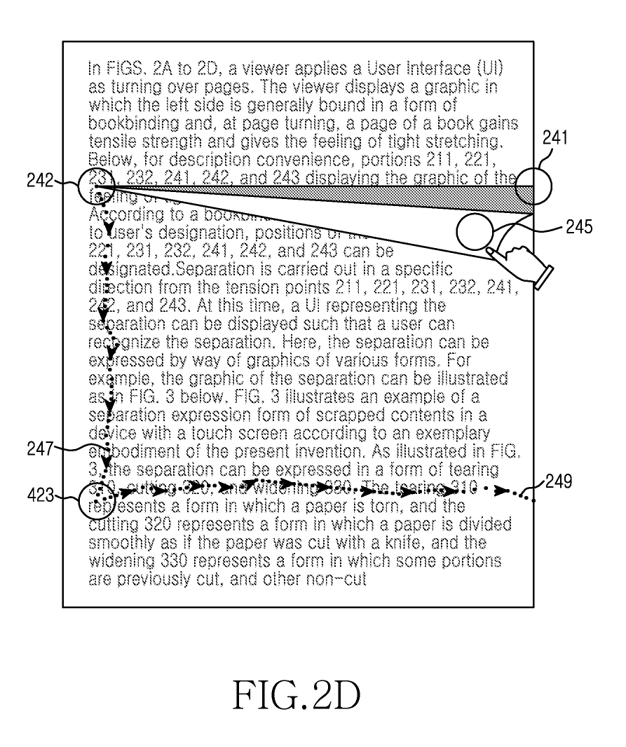

FIGS. 2A to 2D illustrate a scrapping method in a device with a touch screen according to the invention.

In FIGS. 2A to 2D, a viewer operates a User Interface (UI) to virtually turn over pages. The viewer displays a graphic in which the left side is generally bound in a form of bookbinding and, at page turning, a page of a book gains tensile strength and gives the feeling of tight stretching. Portions 211, 221, 231, 232, 241, 242, and 243, display the graphic of the feeling of tight stretching are called “tension points”. According to a bookbinding form of a book, or according to user's designation, positions of the tension points 211, 221, 231, 232, 241, 242, and 243 can be designated. Separation is carried out in a specific direction from the tension points 211, 221, 231, 232, 241, 242, and 243. A UI representing the separation is displayed such that a user can recognize the separation.

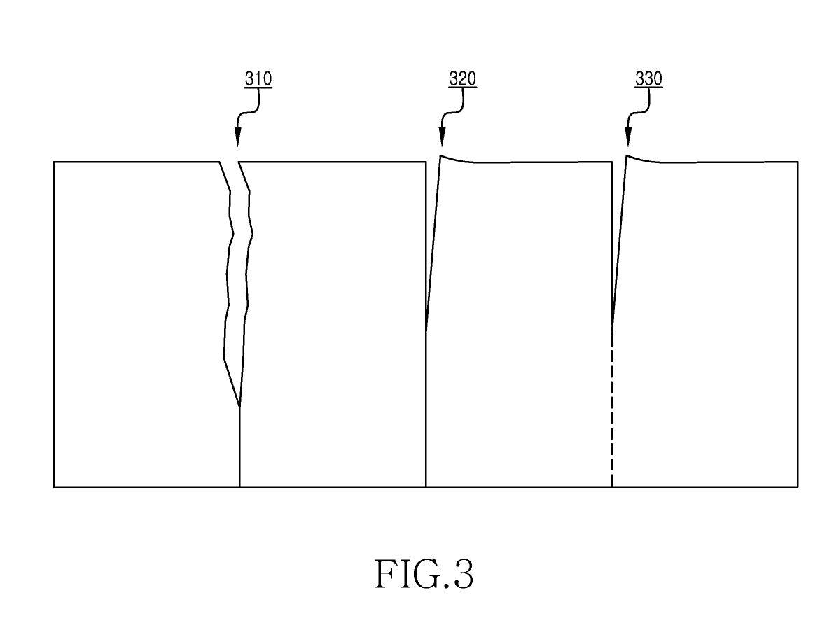

As shown, the separation is expressed by way of graphics of various forms. For example, the graphic of the separation may be expressed in at least one form illustrated as in FIG. 3. That is, FIG. 3 illustrates an example of a separation expression form of scrapped contents in a device with a touch screen according to one embodiment of the invention. The separation is expressed in FIG. 3 in a form of tearing 310, cutting 320, and widening 330. The tearing 310 is meant to represent a paper being torn. The cutting 320 is meant to represent a paper being divided smoothly as if the paper was cut with a knife. The widening 330 is meant to represent some portions that were previously cut, and other non-cut portions that are cut and detached at a time stretching occurs.

According to the invention, the tearing, the cutting, and the widening are merely expression schemes of the UI, and scrap is actually implemented for regions distinguished by straight lines, unlike the expression schemes. According to another embodiment of the invention, the tearing, the cutting, and the widening are expression schemes of the UI and simultaneously define actually scrapped portions. If an additional tension point is not generated in a progress direction of separation, the separation continuously proceeds in the first progress direction. FIGS. 2A to 2D are each described in further detail hereinafter.

FIG. 2A illustrates a case where a user does not designate a tension point. Where the user does not designate a specific point, a tension point 211 is positioned in a bookbinding portion of a book on a UI. According to the movement of a touch input 215, the first page turning proceeds, and scrap proceeds if a predefined required condition is met. The scrap proceeds in the movement direction of the touch input 215 from the tension point 211, i.e., downward in a case of FIG. 2A. The scrapped region is a region of a direction in which the touch input 215 is generated on a basis of a progress trace of separation 217, i.e., a region of the right side in a case of FIG. 2A. Hence, the separation progress trace 217 is expressed by a UI of a form of virtual tearing. Please note that the phrase “separation progress trace” may be used interchangeably herein with the phrase “separation line.”

FIG. 2B illustrates a case where a user designates one tension point. Where the user designates a specific point, a tension point 221 is positioned in the designated point on a UI. According to the movement of a touch input 225, the first page turning proceeds. A scrap proceeds if a predefined required condition is met. That is, the scrap proceeds in the movement direction of the touch input 225 from the tension point 221, i.e., downward in FIG. 2B. The scrapped portion is a portion of a direction in which the touch input 225 is generated on a basis of a separation line 227, i.e., a portion of the right side in FIG. 2B. In FIG. 2B, the separation line 227 is expressed by the UI in a form of virtual tearing.

FIG. 2C illustrates a case where a user designates two tension points 231 and 232. Two or more tension points 231 and 232 are used in a case where the user intends to begin scrap from a middle end not a top end of a page. The two tension points 231 and 232 determine a position where scrap is begun. In this case, the position where the scrap is begun is not a position where page turning is possible, so the scrap just proceeds according to the movement of a touch input 235. The scrap proceeds in the movement direction of the touch input 235 from the 2nd tension point 232, i.e., downward as shown in FIG. 2C. The scrapped portion is a portion of a direction in which the touch input 235 is generated on a basis of a separation line 237, i.e., the right side in FIG. 2C. In FIG. 2C, the separation line 237 is expressed by the UI in a form of virtual tearing.

FIG. 2D illustrates a case where a user designates three tension points 241, 242, and 243. Three or more tension points 241, 242, and 243 are used in a case where the user intends to begin scrap from an upper and middle end instead of a top end of a page and end the scrap at a lower and middle end instead of a bottom end of the page. The 1st and 2nd tension points 241 and 242 determine a position where scrap is begun. In this case, the position where the scrap is begun is not a position where page turning is possible, so the scrap just proceeds according to the movement of a touch input 245. The scrap proceeds in the movement direction of the touch input 245 from the 2nd tension point 242, i.e., downward in FIG. 2D. The scrapped portion is a portion of a direction generated in the touch input 245 on a basis of a 1st separation line 247, i.e., a portion of the right side of FIG. 2D. As illustrated in FIG. 2D, the 1st separation line 247 is expressed by a UI of a form of virtual tearing. While separation proceeds along the 1st separation line 247, the 3rd tension point 243 determines a position where the scrap is ended. The scrapped portion is a portion of a direction in which the touch input 245 is generated on a basis of a 2nd separation line 248, i.e., a portion of the upside in FIG. 2D. As illustrated in FIG. 2D, the 2nd separation line 248 is expressed by a UI of a form of virtual tearing. The 3rd tension point 243 can be designated before the progress of the 1st separation line 247, or designated in course of the progress of the 1st separation line 247.

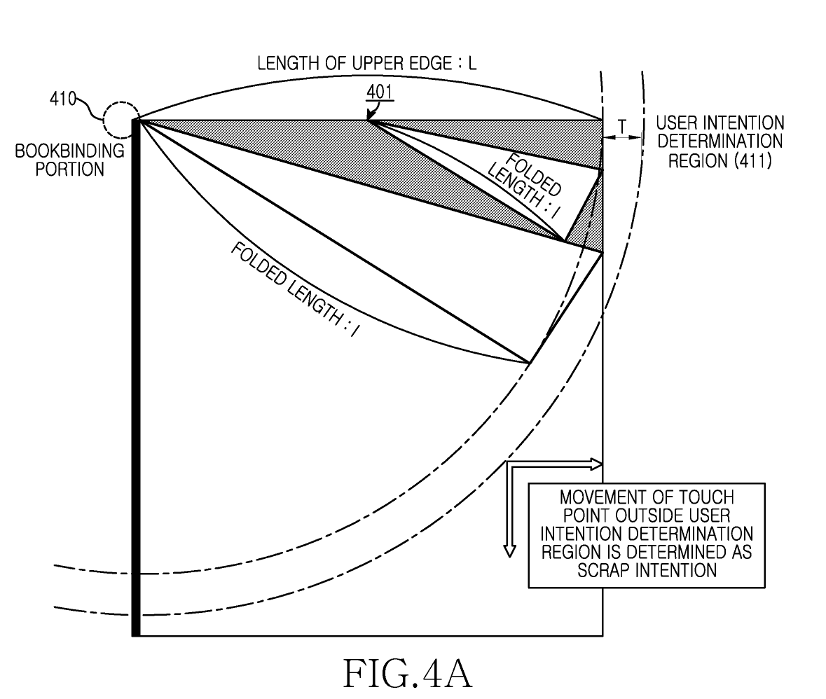

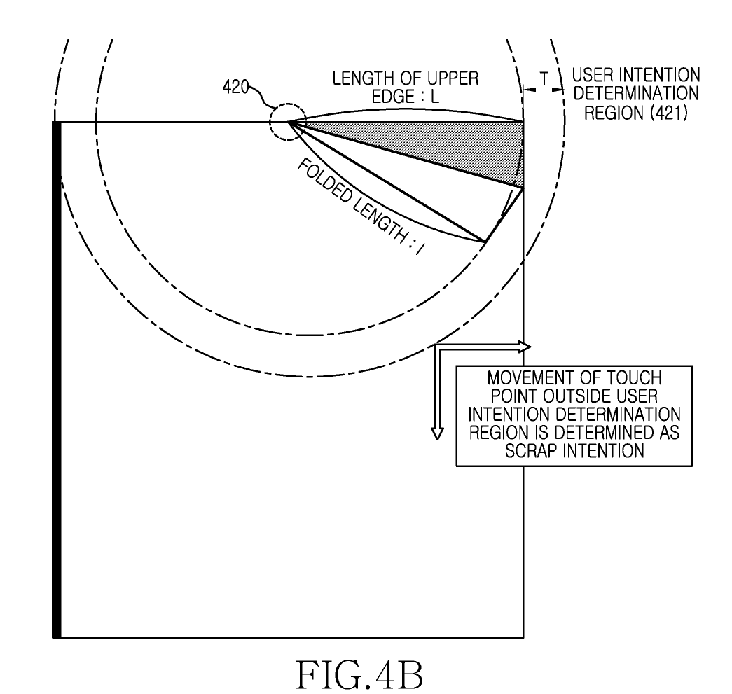

FIGS. 4A and 4B illustrate a method for determining scrap or non-scrap in a device with a touch screen according to an embodiment of the invention.

Referring to FIG. 4A, as page turning takes place, a folded length (l) is gradually increased as an end point 401 of a folded portion approaches a bookbinding line. When the end point 401 of the folded portion reaches a tension point 410 on the bookbinding line, the folded length (l) is equal to a length (L) of an upper edge of a book. In FIG. 4A, a user intention determination region 411 denotes a range from the upper edge length (L) to a constant margin length (T). That is, the user intention determination region 411 denotes a common region between an outside portion of a circle of a radius (L) centering on the tension point 410 and an inside portion of a circle of a radius (L+T) centering on the tension point 410. If a touch input extends out of the user intention determination region 411 in course of the page turning, the device determines that a scrap command occurs.

Further, upon recognizing a scrap command, the device proceeds with separation of a scrap region without reconfirming a position of a touch input. This is because there is no need to once more determine a user's intention since scrap has begun already. Also, where a touch input is ended in course of scrap, the device determines that a user intends to stop the scrap, so stopping the scrap. In another embodiment, the condition for determining an intention to stop the scrap is defined differently. That is, the device with the touch screen defines a ‘scrap mode’ for recognizing a scrap command, which scrap command is recognized according to a specific input pattern generated at the time of operating in the scrap mode.

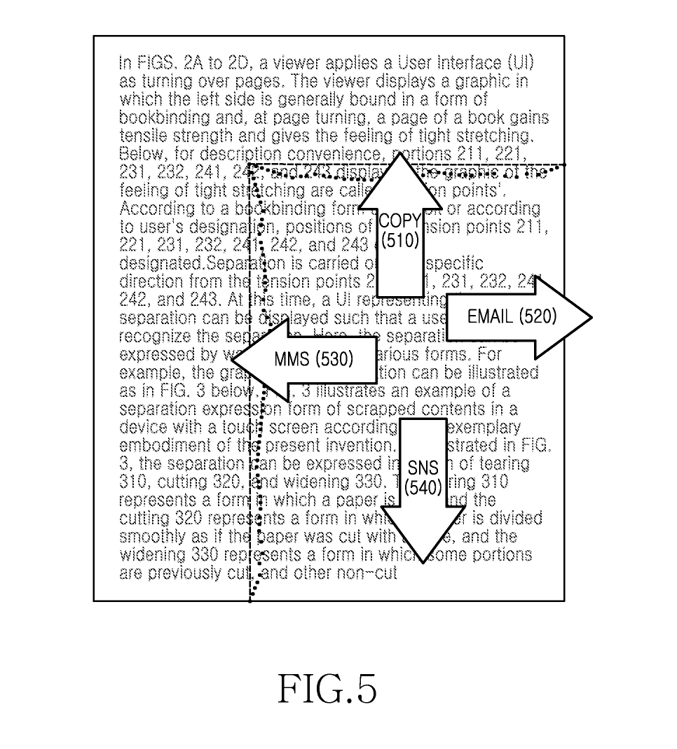

After the scrap is achieved through the above process, the device processes scrapped contents according to the whether a predefined input pattern has occurred. The predefined input pattern can include throwing a scrapped object in a specific direction, such as depicted in FIG. 5 below.

FIG. 5 illustrates a method for processing scrapped contents in a device with a touch screen according to the invention.

Referring to FIG. 5, upward movement is defined as copying 510, rightward movement is defined as electronic mail (e-mail) 520, leftward movement is defined as Multimedia Message Service (MMS) transmission 530, and downward movement is defined as a Social Network Service (SNS) 540. Defined movement can include at least one of a ‘throw’ and a ‘drag’. Here, the ‘drag’ denotes a manipulation of moving a touch input as maintaining the touch input on a corresponding object, and the ‘throw’ denotes a manipulation of removing a touch input before movement completion in course of the ‘drag’.

Further, where scrapped contents include a text, the device can extract the text from a scrapped region, and process the extracted text in a scheme corresponding to a corresponding input pattern. According to an embodiment illustrated in FIG. 5, the device displays functions corresponding to respective directions after scrap is completed.

An operation and construction of a device performing scrap as above are described below in detail with reference to the drawings. Below, an embodiment is described on the premise that an application displays contents in a form of a book. So, in the following description, a ‘page’ represents a scrap possible region. In a case where contents are displayed in a form other than a book form, the ‘page’ can be replaced with an other expression.

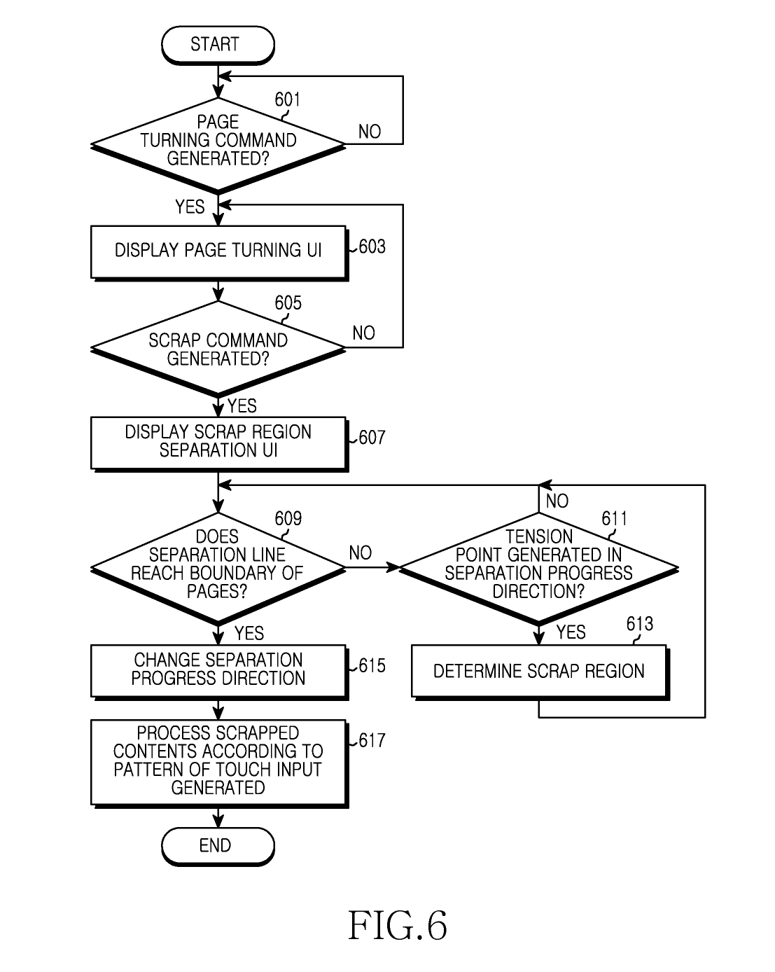

FIG. 6 illustrates an operation procedure of a device with a touch screen according to one embodiment of the invention in which scrap starts from an edge folded at paging turning, such as previously shown in FIG. 2A or 2B.

Referring to FIG. 6, in step 601, the device determines whether a paging turning command occurs. In other words, the device determines if an event corresponding to paging turning should occur in response to a user's manipulation. The page turning event can be defined differently according to a concrete exemplary implementation. For example, the event corresponding to the paging turning can include dragging or throwing a corner of a page.

If the paging turning command is generated in step 601, the device proceeds to step 603 and displays a page turning UI. That is, the device displays a predefined graphic corresponding to page turning. For example, the page turning UI can include a graphic in which a page is gradually inverted from a corner of the page.

After that, the device proceeds to step 605 and determines if a scrap command occurs in course of displaying the page turning UI. In other words, the device determines if an event corresponding to scrap should occur in response to a user's manipulation. The event corresponding to the scrap is defined differently according to a concrete exemplary implementation. For example, as illustrated in FIG. 4A, the event corresponding to the scrap can be defined as increasing a distance between a tension point and a touch input in a page turning state by a constant length, that is more than a length of an upper edge of a page.

In another example, as illustrated in FIG. 4B, the event corresponding to the scrap is defined as generating a tension point by a user's manipulation in a non-folded position along an upper edge of a page in a page turning state. Here, an event corresponding to the tension point by the user's manipulation can be defined variously according to a concrete exemplary implementation. For example, the event corresponding to the tension point by the user's manipulation can be defined as a simple touch input, a long touch input of more than a constant time, a double click and the like. Below, for description convenience, the ‘tension point by user's manipulation’ is called a “user designation tension point.” Alternatively, the event corresponding to the scrap can be defined as a predefined key input, a predefined touch input pattern and the like. Determining the generation of the scrap command includes recognizing the scrap command and determining a starting point of scrap and a direction.

If the scrap command occurs in step 605, the device proceeds to step 607 and displays a scrap region separation UI. That is, the device separates a scrap region in a scrap direction from the starting point of scrap, and displays a graphic representing a separation line. The progress of the separation can be expressed in a form of tearing, cutting, detaching, widening and the like. A degree of tearing, i.e., a degree of bending, can be determined according to a movement speed or acceleration of a touch input included in the scrap command.

Subsequently, the device proceeds to step 609 and determines if the separation line reaches a boundary of pages while displaying the scrap region separation UI. In other words, the device determines if the scrap separation should not proceed. If the separation line reaches the boundary of pages in step 609, the device proceeds to step 615 below.

If the separation progress does not reach the boundary of pages in step 609, however, the device proceeds to step 611 and determines if an additional user designation tension point is generated in a separation progress direction. Whether the additional user designation tension point is generated in the separation progress direction is continuously monitored until the separation progress reaches the boundary of pages.

If the additional user designation tension point is generated in the separation progress direction in step 611, the device proceeds to step 613 and changes the separation progress direction. Here, the changed progress direction is determined considering at least one of the original progress direction, a position of generation of an additional user designation tension point, and a direction of a scrap region based on a progress direction. For example, when separation proceeds in a horizontal direction and a scrap region is below the separation line, if a user designation tension point is generated, the separation progress direction is changed into the downside. But when separation proceeds in a vertical direction and a scrap region is at the right side of the separation line, if a user designation tension point is generated, the separation progress direction is changed into the right side. After that, the device returns to step 609.

If the separation line reaches the page boundary in step 609, the device proceeds to step 615 and determines a scrap region. That is, the device recognizes that scrap region separation is ended, and fixes the scrap region. The fixed scrap region is a region specified by at least one separation line and boundary of pages. In other words, the fixed scrap region is a region surrounded by at least one separation line and at least one boundary of pages. A boundary of the scrap regions can be expressed as the separation line or as a straight line irrespective of the expression form of the separation line.

After that, the device proceeds to step 617 and processes scrapped contents according to a pattern of a touch input generated. In other words, if the pattern of the user's touch input is consistent with one of predefined patterns, the device processes the scrapped contents in a scheme corresponding to the consistent pattern. For instance, the predefined patterns include a drag of a specific direction, a throw and the like, and different processing can correspond according to the directions of the drag, the throw and the like. The processing also can include copying, e-mail transmission, SNS, message composition and the like. In an embodiment, the device can display a screen, an icon, a menu and the like of informing of each input pattern and processing corresponding to this input pattern.

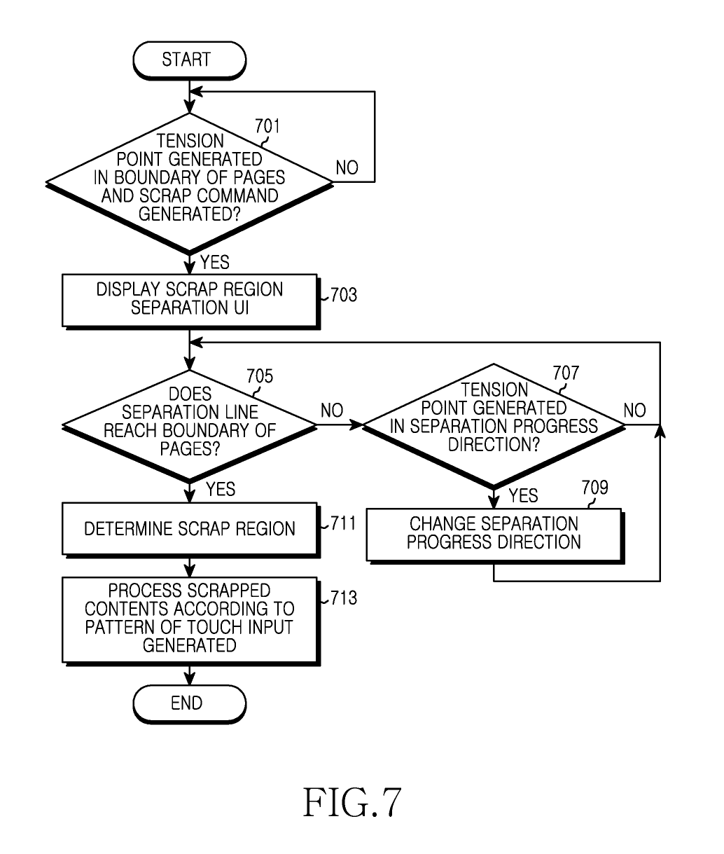

FIG. 7 illustrates an operation procedure of a device with a touch screen according to another exemplary embodiment of the invention.

Referring to FIG. 7, in step 701, the device determines if a user designated tension point is generated at a boundary of pages, and a scrap command has occurred. Here, an event corresponding to the user designation of a tension point and an event corresponding to scrap can be defined variously according to a concrete exemplary implementation. For example, the event corresponding to the user designation of a tension point can be defined as a simple touch input, a long touch input of more than a predetermined time, a double click and the like. And, the event corresponding to the scrap can be defined as a drag within a predetermined distance from the user designation tension point and the like. Alternatively, the event corresponding to the scrap can be defined as a predefined key input, a predefined touch input pattern and the like. Determining the generation of the scrap command includes recognizing the scrap command and determining a starting point of scrap and a direction.

If the scrap command occurs in step 701, the device proceeds to step 703 and displays a scrap region separation UI. That is, the device separates a scrap region in a scrap direction from the starting point of scrap, and displays a graphic representing a separation line. The progress of the separation can be expressed in a form of tearing, cutting, detaching, widening and the like. A degree of tearing, i.e., a degree of bending, is determined according to a movement speed or acceleration of a touch input included in the scrap command.

After that, the device proceeds to step 705 and determines if the separation line reaches the boundary of pages in course of displaying the scrap region separation UI. In other words, the device determines if the scrap separation should not proceed. If the separation line reaches the boundary of pages in step 705, the device proceeds to step 711 below.

If the separation progress does not reach the boundary of pages in step 705, the device proceeds to step 707 and determines if an additional user designation tension point has been generated in a separation progress direction. Whether the user designation tension point is generated in the separation progress direction is continuously monitored until the separation progress reaches the boundary of pages.

If the additional user designation tension point is generated in the separation progress direction in step 707, the device proceeds to step 709 and changes the separation progress direction. Here, the changed progress direction is determined considering at least one of the original progress direction, a position of generation of an additional user designation tension point, and a direction of a scrap region based on a progress direction. For example, when separation proceeds in a horizontal direction and a scrap region is below the separation line, if a user designation tension point is generated, the separation progress direction is changed into the downside if a user designation tension point is generated. When separation proceeds in a vertical direction and the scrap region is at the right side of the separation line, the separation progress direction is changed into the right side if the user designation tension point is generated. After that, the device returns to step 705.

If the separation line reaches the boundary of pages in step 705, the device proceeds to step 711 and determines a scrap region. That is, the device recognizes that separation of the scrap region is ended, and fixes the scrap region. The fixed scrap region is a region specified by at least one separation line and boundary of pages. In other words, the fixed scrap region is a region surrounded by at least one separation line and at least one boundary of pages. A boundary of the scrap regions can be an expression form of the separation line or can be defined as a straight line irrespective of the expression form of the separation line.

The device then proceeds to step 713 and processes scrapped contents according to a pattern of a touch input generated. In other words, if the pattern of the user's touch input is consistent with one of predefined patterns, the device processes the scrapped contents in a scheme corresponding to the consistent pattern. For example, the predefined patterns can include a drag of a specific direction, a throw and the like, and different processing can correspond according to the directions of the drag, the throw and the like. Also, the processing can include copying, e-mail transmission, SNS, message composition and the like. Further, the device can display a screen, an icon, a menu and the like of informing of each input pattern and processing corresponding to this input pattern.

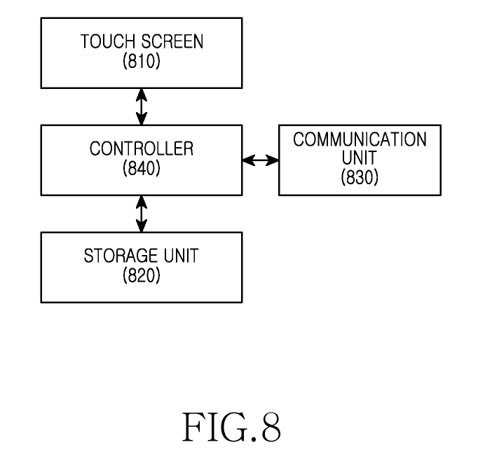

FIG. 8 is a block diagram illustrating a device with a touch screen according to an embodiment of the invention.

As illustrated in FIG. 8, the device includes a touch screen 810, a storage unit 820, a communication unit 830, and a controller 840.

The touch screen 810 performs a display function of displaying visual information and an input function of recognizing a touch input by a physical touch. That is, according to the control of the controller 840, the touch screen 810 displays a state of the device, a numeral, a character, an image, a video and the like in a visual form that a user can view. In addition, the touch screen 810 provides information of a position of generation of a touch input by a user, a pressure, a pressure range and the like to the controller 840. For the display function, the touch screen 810 can include one of a Cathode-Ray Tube (CRT), a Liquid Crystal Display (LCD), and an Organic Light-Emitting Diode (OLED), without limitation. For the input function, the touch screen 810 can include a touch panel.

The storage unit 820 stores data of a basic program for an operation of the device, such as an application program, setup information, user contents and the like. For instance, the storage unit 820 can store electronic contents of an electronic book, a Web page and the like. In addition, the storage unit 820 provides the stored data in response to a request of the controller 840. The communication unit 830 provides an interface for the device to perform communication through a wired channel or a wireless channel. In an embodiment, the communication unit 830 can be excluded.

The controller 840 controls the general functions of the device. For example, the controller 840 generates and provides video data to the touch screen 810, and performs a corresponding operation function using information on a touch input provided from the touch screen 810. In an embodiment, the controller 840 performs a scrap function using a tension point and a function of processing scrapped contents. The scrap function is described below in detail.

First, the controller 840 determines whether a scrap command occurs. An event corresponding to scrap can be defined differently according to a concrete exemplary implementation. For example, the event corresponding to the scrap can be defined as increasing, by a constant length, a distance between a tension point and a touch input in a page turning state more than a length of an upper edge of a page. Also, the event corresponding to the scrap can be defined as generating a tension point by a user's manipulation in a non-folded position of the upper edge of the page in the page turning state. In addition, the event corresponding to the scrap can be defined as generating a user designation tension point at a boundary of pages and generating a drag within a predetermined distance from the user designation tension point. Moreover, the event corresponding to the scrap can be defined as a predefined key input, a predefined touch input pattern and the like.

Determining the generation of the scrap command includes recognizing the scrap command and determining a starting point of scrap and a direction. Also, an event corresponding to the user designation of a tension point can be defined variously according to a concrete exemplary implementation. For example, the event corresponding to the user designation of a tension point can be defined as a simple touch input, a long touch input of more than constant time, a double click and the like.

If the generation of the scrap command is recognized, the controller 840 separates a scrap region in a scrap direction from the starting point of scrap, and displays a graphic representing a separation line. The separation progress then can be expressed in a form of tearing, cutting, detaching, widening and the like. Before the separation line reaches a boundary of pages, if an additional user designation tension point is generated in a separation progress direction, the controller 840 changes the separation progress direction in consideration of at least one of the original progress direction, a position of generation of the additional user designation tension point, and a direction of a scrap region based on a progress direction. If the separation line reaches the boundary of pages, the controller 840 recognizes that separation of the scrap region is ended, and fixes the scrap region as a region specified by at least one separation line and boundary of pages. A boundary of the scrap regions can be the same as a form of the separation line, or can be defined as a straight line apart from the separation line.

After fixing the scrap region, the controller 840 processes scrapped contents according to a pattern of a touch input generated. For example, the pattern of the touch input can include a drag of a specific direction, a throw and the like, and different processing can be defined according to the directions of a drag, a throw and the like. Also, the processing can include copying, e-mail transmission, SNS, message composition and the like. Further, the controller 840 can display a screen, an icon, a menu and the like of informing each input pattern and processing corresponding to this input pattern.

As described above, exemplary embodiments of the present invention can provide analog sensation and simultaneously, provide a scrapping scheme comprehensive naturally, intuitively, and easily compared to a human gesture in a device with a touch screen.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for scrapping in a device with a touch screen, comprising:
determining whether a scrap command occurs;
if the scrap command is determined to have occurred, proceeding with separation of a scrap region from a tension point; and
if a separation line representing a progress trace of separation reaches a boundary of possible scrap regions, determining a region surrounded by at least one separation line and at least one boundary as the scrap region.

2. The method of claim 1, further comprising:
displaying the separation line through the touch screen.

3. The method of claim 2, wherein the separation line is expressed in one form of tearing, cutting, and widening.

4. The method of claim 1, further comprising:
where a tension point is generated in the separation progress direction before the separation line reaches the boundary of the scrap possible regions, changing the separation progress direction.

5. The method of claim 4, wherein the changed separation progress direction is determined according to at least one of the original progress direction, a position of generation a tension point, and a direction of a scrap region based on a progress direction.

6. The method of claim 5, wherein if the original progress direction is a horizontal direction, the separation progress direction is changed into a direction in which a scrap region exists among the upside and the downside.

7. The method of claim 5, wherein if the original progress direction is a vertical direction, the separation progress direction is changed into a direction in which a scrap region exists among the right side and the left side.

8. The method of claim 1, wherein the scrap command is determined to have occurred where a distance between a tension point on a bookbinding line and a touch input in a page turning state exceeds the sum of a length of an upper edge of a page and a margin length.

9. The method of claim 1, wherein the scrap command is determined to have occurred where a tension point by user's manipulation is generated in a non-folded position of an upper edge of a page in a page turning state.

10. The method of claim 1, wherein the scrap command is determined to have occurred where a tension point by user's manipulation is generated in a boundary of scrap possible regions and a drag within a constant distance from the tension point is generated.

11. The method of claim 1, further comprising:
after determining the scrap region, processing scrapped contents in a scheme corresponding to the consistent pattern if a pattern of a user's touch input is consistent with one of predefined patterns.

12. The method of claim 11, further comprising:
after determining the scrap region, displaying processing schemes corresponding to predefined patterns through the touch screen.

13. The method of claim 11, wherein the predefined patterns comprise at least one of upward movement, downward movement, rightward movement, and leftward movement.

14. The method of claim 11, wherein the scheme corresponding to the pattern comprises at least one of copying, electronic mail (e-mail) transmission, message transmission, and SNS uploading.

15. An apparatus with a touch screen, the apparatus comprising:
a touch screen for recognizing a user's touch input; and
a controller for determining whether a scrap command input as the touch input has occurred, and if the scrap command input has occurred, proceeding with separation of a scrap region from a tension point, and, if a separation line representing a progress trace of separation reaches a boundary of possible scrap possible regions, determining a region surrounded by at least one separation line and at least one boundary as the scrap region.

16. The apparatus of claim 15, wherein the controller controls to display the separation line through the touch screen.

17. The apparatus of claim 16, wherein the separation line is expressed in one form of tearing, cutting, and widening.

18. The apparatus of claim 15, wherein the controller changes the separation progress direction, if a tension point is generated in the separation progress direction before the separation line reaches the boundary of the scrap possible regions.

19. The apparatus of claim 18, wherein the changed separation progress direction is determined according to at least one of the original progress direction, a position of generation a tension point, and a direction of a scrap region based on a progress direction.

20. The apparatus of claim 19, wherein the controller changes the separation progress direction into a direction in which a scrap region exists among the upside and the downside, in a case where the original progress direction is a horizontal direction.

21. The apparatus of claim 19, wherein the controller changes the separation progress direction into a direction in which a scrap region exists among the right side and the left side, in a case where the original progress direction is a vertical direction.

22. The apparatus of claim 15, wherein the scrap command is determined to have occurred where a distance between a tension point on a bookbinding line and a touch input in a page turning state exceeds the sum of a length of an upper edge of a page and a margin length.

23. The apparatus of claim 15, wherein the scrap command is determined to have occurred where a tension point by user's manipulation is generated in a non-folded position of an upper edge of a page in a page turning state.

24. The apparatus of claim 15, wherein the scrap command is determined to have occurred where a tension point by user's manipulation is generated in a boundary of scrap possible regions and a drag within a constant distance from the tension point is generated.

25. The apparatus of claim 15, wherein, after determining the scrap region, the controller processes scrapped contents in a scheme corresponding to the consistent pattern if a pattern of a user's touch input is consistent with one of predefined patterns.

26. The apparatus of claim 25, wherein, after determining the scrap region, the controller controls to display processing schemes corresponding to predefined patterns through the touch screen.

27. The apparatus of claim 25, wherein the predefined patterns comprise at least one of upward movement, downward movement, rightward movement, and leftward movement.

28. The apparatus of claim 25, wherein the scheme corresponding to the pattern comprises at least one of copying, electronic mail (e-mail) transmission, message transmission, and SNS uploading.
